(19) United States
(12) Patent Application Publication
(10) Pub. No.: US 2010/0235669 A1
(43) Pub. Date: Sep. 16, 2010

(54) MEMORY POWER CONSUMPTION REDUCTION SYSTEM, AND METHOD AND PROGRAM THEREFOR

(76) Inventor: KATSUYUKI MIYAMUKO, Tokyo (JP)

Correspondence Address: Mr. Jackson Chen, 6535 N. STATE HWY 161, IRVING, TX, 75039, US

(21) Appl. No.: 12/706,764

(22) Filed: Feb. 17, 2010

(30) Foreign Application Priority Data
Mar. 11, 2009 (JP) 2009-058745

(51) Int. Cl. G06F 1/32; G06F 12/00; G06F 12/02; G06F 9/455

(52) U.S. Cl. 713/324; 711/170; 718/1; 711/E12.001; 711/E12.002

(57) ABSTRACT

Disclosed is a memory power consumption reduction system that includes a memory allocation section, which allocates an area of a plurality of physical memories included in a physical information processing device to a process of a virtual machine when the virtual machine is to be controlled with a VMM; a memory compaction section, which performs memory compaction when the physical memory area allocated to the process by the memory allocation section is deallocated upon termination of the process; and a power supply control section, which exercises control so as to shut off the power supply to a physical memory that is unused as a result of memory compaction by the memory compaction section.

This application is based upon and claims the benefit of priority from Japanese patent application No. 2009-058745, filed on Mar. 11, 2009, the disclosure of which is incorporated herein in its entirety by reference.

### TECHNICAL FIELD

The present invention relates to a memory power consumption reduction system, memory power consumption reduction method, and memory power consumption reduction program for reducing the power consumption of a memory during the use of a VMM (Virtual Machine Manager).

### BACKGROUND ART

The cost of electricity accounts for a large percentage of the running cost of a data center. One reason is that the memory of a common server device constantly consumes electrical power even when the percentage of memory usage is low. From the viewpoint of energy efficiency, therefore, it is necessary to reduce the power consumption of the server device.

A memory power supply management device disclosed, for instance, in Japanese Patent Application Publication JP-P2008-262451A divides a memory region into a plurality of banks and exercises power-saving control.

When a virtual machine running on the device disclosed in Japanese Patent Application Publication JP-P2008-262451A comes to a stop, the device locates a memory bank whose memory area is entirely available, and then exercises power-saving control for the located memory bank. However, the device merely performs a process when the virtual machine is brought to a stop, and cannot reduce the power consumption of the memory allocated to a running virtual machine.

### SUMMARY OF THE INVENTION

A typical object of the present invention is to provide a memory power consumption reduction system, a memory power consumption reduction method, and a memory power consumption reduction program that are capable of reducing the power consumption of a memory during the use of a VMM even when a virtual machine is running.

According to an exemplary aspect of the present invention, there is provided a memory power consumption reduction system including a memory allocation section, a memory compaction section, and a power supply control section. The memory allocation section allocates a plurality of physical memory areas included in a physical information processing device to a process of a virtual machine when the virtual machine is to be controlled through the use of a VMM. The memory compaction section performs memory compaction when the memory allocation section deallocates the physical memory areas, which are allocated to the process, upon termination of the process. When an available physical memory is generated as a result of memory compaction by the memory compaction section, the power supply control section exercises control to shut off the power supply to the available physical memory.

According to another exemplary aspect of the present invention, there is provided a memory power consumption reduction method including the steps of: allocating a plurality of physical memory areas included in a physical information processing device to a process of a virtual machine when the virtual machine is to be controlled through the use of a VMM; performing memory compaction when the physical memory areas allocated to the process are deallocated upon termination of the process; and exercising control to shut off the power supply to an available physical memory that is generated as a result of memory compaction.

According to still another exemplary aspect of the present invention, there is provided a memory power consumption reduction program for causing a computer to execute a memory allocation process for allocating a plurality of physical memory areas included in a physical information processing device to a process of a virtual machine when the virtual machine is to be controlled through the use of a VMM; execute a memory compaction process for performing memory compaction when the physical memory areas allocated to the process are deallocated upon termination of the process; and execute a power supply control process for exercising control to shut off the power supply to an available physical memory that is generated as a result of memory compaction.

### BRIEF DESCRIPTION OF THE DRAWINGS

FIG. 1 is a block diagram illustrating an exemplary configuration of a memory power consumption reduction system according to the present invention.

FIGS. 2A and 2B are flowcharts illustrating exemplary processes performed by the memory power consumption reduction system.

FIGS. 3A and 3B are flowcharts illustrating exemplary processes performed by the memory power consumption reduction system.

FIG. 4 is a flowchart illustrating an example of a memory compaction process performed by a physical memory management section 211.

FIG. 5 is a block diagram illustrating an exemplary minimum configuration of the memory power consumption reduction system.

### DESCRIPTION OF EXEMPLARY EMBODIMENT

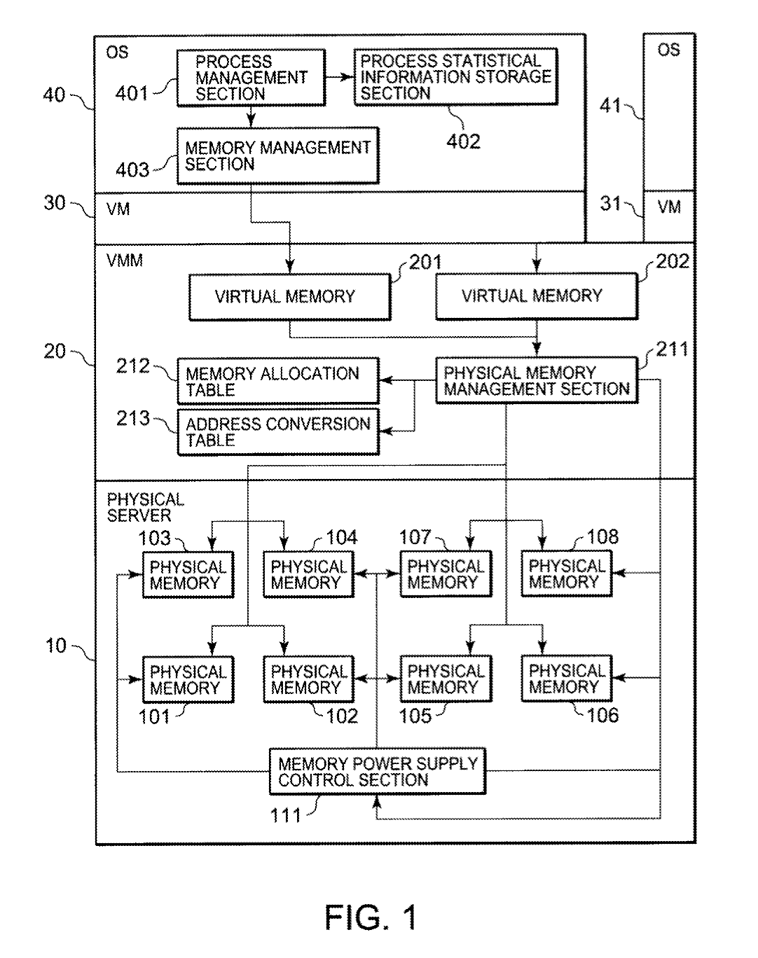

An exemplary embodiment of the present invention will now be described with reference to the accompanying drawings. FIG. 1 is a block diagram illustrating an exemplary configuration of a memory power consumption reduction system according to the present invention. As shown in FIG. 1, a physical server 10 includes a plurality of physical memories 101 to 108 and a memory power supply control section 111, which controls the power supply for the physical memories. Specifically, the physical server 10 is implemented by a server device or other information processing device that operates in accordance with a program.

The present exemplary embodiment is described, for instance, by stating that a process is executed by a VMM or by means included in the VMM. To be more precise, however, a CPU for the physical server 10 performs a process by using a hard disk drive or other hardware resource in accordance with the VMM, which is a program.

As shown in FIG. 1, the VMM (Virtual Machine Manager) 20 is installed on the physical server 10. Specifically, the VMM 20 is implemented by a program installed on the physical server 10. The VMM 20 is capable of dividing and managing resources (physical memories, etc.) included in the physical server 10. The VMM 20 is also capable of controlling a virtual machine (VM) 30 that is implemented by virtualizing a resource of the physical server 10.

As shown in FIG. 1, the VMM 20 includes virtual memories 201, 202, a physical memory management section 211, a memory allocation table 212, and an address conversion table 213.

The virtual memories are implemented by the VMM 20, which uses physical memories provided as resources of the physical server 10. In the present exemplary embodiment, an OS 40 does not access a physical memory included in the physical server 10 by directly specifying the address space of the physical memory, but accesses the physical memory by specifying the virtual address space of a virtual memory managed by the VMM 20. In this instance, the VMM 20 converts the specified virtual address space to a physical address space and mediates the access of the OS 40 to the physical memory.

The physical memory management section 211 is capable of managing the physical memories 101 to 108 with the physical memories 101 to 108 classified into short-lived process memories and long-lived process memories. When the amount of physical memory use is decreased, the physical memory management section 211 can perform a memory compaction process by moving a page stored in one physical memory to another physical memory for rearrangement purposes.

The physical memory management section 211 performs a memory compaction process with long-lived process physical memories differentiated from short-lived process physical memories. The physical memory management section 211 performs a memory compaction process on a long-lived process physical memory with low frequency. For example, the physical memory management section 211 can be set to perform a memory compaction process for a short-lived process only and refrain from performing a memory compaction process for a long-lived process. When an available physical memory is generated as a result of memory compaction, the physical memory management section 211 can cause the memory power supply control section 111 to shut off the power supply to the available physical memory.

The memory allocation table 212 contains information that indicates a process assigned to an address of a virtual memory. Specifically, the memory allocation table 212 is implemented by an optical disk drive or magnetic disk drive included in the physical server 10 or by a memory or other storage device.

The address conversion table 213 contains information that shows the relationship between virtual memory addresses and physical memory addresses. Specifically, the address conversion table 213 is implemented by an optical disk drive or magnetic disk drive included in the physical server 10 or by a memory or other storage device. The address conversion table 213 distinguishes between the addresses of a short-lived physical memory and the addresses of a long-lived physical memory.

Further, the physical server 10 has an operating system (OS) 40. Specifically, the OS 40 is implemented by a program installed on the physical server 10. As shown in FIG. 1, the OS 40 includes a process management section 401, a process statistical information storage section 402, and a memory management section 403.

The present exemplary embodiment is described, for instance, by stating that a process is executed by the OS or by means included in the OS. To be more precise, however, the CPU for the physical server 10 performs a process by using a hard disk drive or other hardware resource in accordance with the OS, which is a program.

The process management section 401 causes the process statistical information storage section 402 to store the average startup time and average memory usage amount of an application (hereinafter referred to as a process) running on the OS.

The process statistical information storage section 402 is managed by the OS 40 to store statistical information including the information about the average startup time and average memory usage amount of each process. Specifically, the process statistical information storage section 402 is implemented by an optical disk, magnetic disk, or other storage device included in the physical server 10.

The memory management section 403 is capable of managing a memory that is used in the VM 30. The memory management section 403 is also capable of sorting processes into short-lived ones and long-lived ones in accordance with the statistical information stored in the process statistical information storage section 402.

An OS 41 and a VM 31 will not be described here because the OS 41 has the same functionality as the OS 40 and the VM 31 has the same functionality as the VM 30. In the present exemplary embodiment, two VMs (VM 30 and VM 31) are virtually generated. However, the number of VMs is not limited to two. Three or more VMs may alternatively be generated.

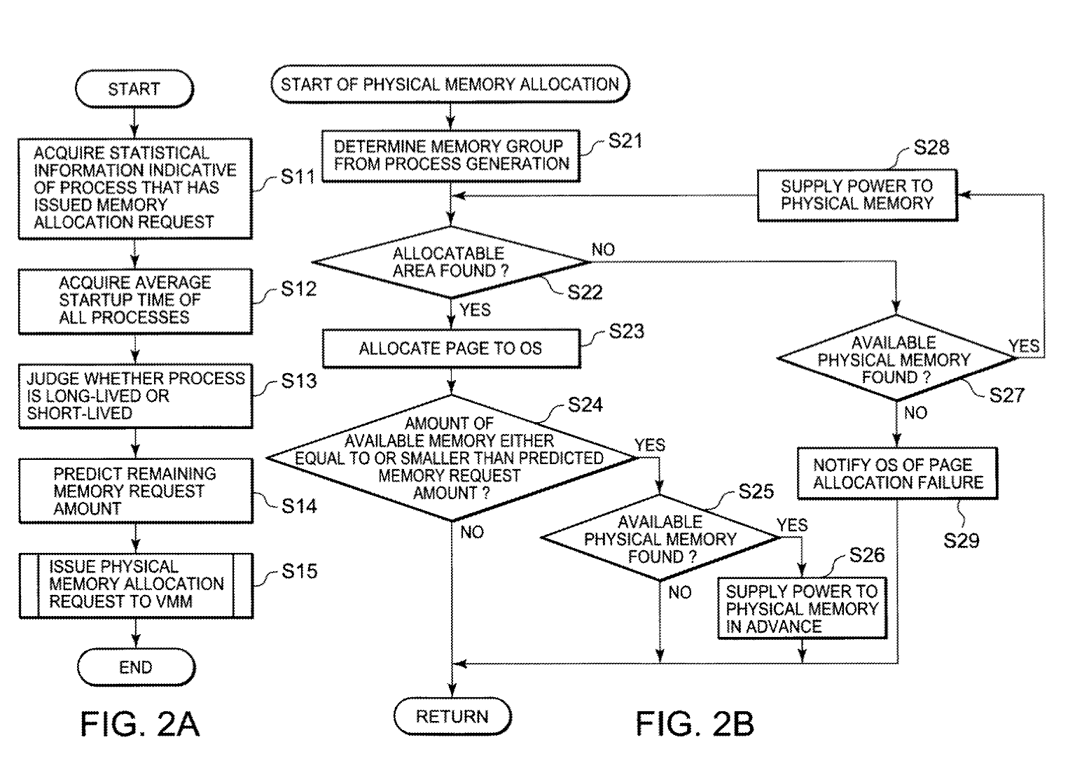

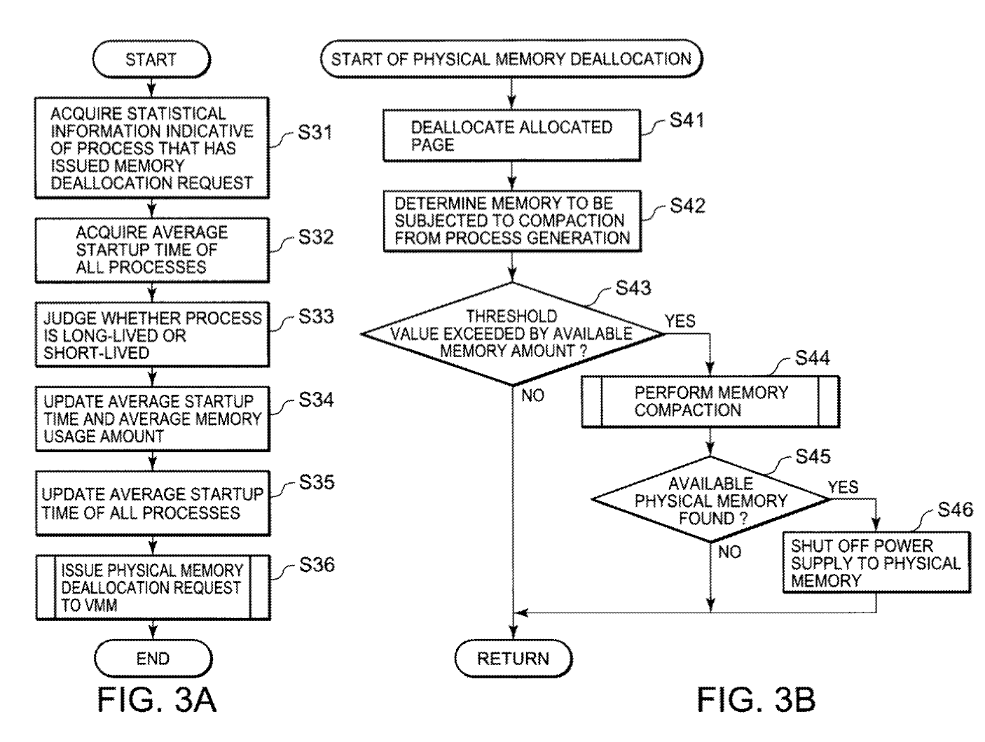

An operation of the memory power consumption reduction system will now be described. FIGS. 2A, 2B, 3A, and 3B are flowcharts illustrating exemplary processes performed by the memory power consumption reduction system.

FIGS. 2A and 2B are flowcharts illustrating exemplary processing operations that the OS 40 and VMM 20 perform when a memory allocation request is executed from a process running on the OS 40.

### 1. Processing Operation Performed by OS 40

First of all, a processing operation performed by the OS 40 will be described with reference to FIG. 2A.

(a) When a process running on the OS 40 executes a memory allocation request, the memory management section 403 accesses the process management section 401 and acquires (inputs) information indicating the process that has executed the memory allocation request (step S11). More specifically, the memory management section 403 acquires (inputs) the average startup time, average memory usage amount, and startup count of the process, which the process management section 401 acquired (extracted) from the process statistical information storage section 402.

(b) Next, the memory management section 403 acquires (inputs) the average startup time of all processes, which the process management section 401 acquired (extracted) from the process statistical information storage section 402 (step S12).

(c) Next, the memory management section 403 compares the acquired (input) average startup time of the process against the average startup time of all processes. If the average startup time of the process is longer than the average startup time of all processes, the memory management section 403 concludes that the process is long-lived. If, on the other hand, the average startup time of the process is shorter than the average startup time of all processes, the memory management section 403 concludes that the process is short-lived (step S13).

(d) Next, the memory management section 403 predicts (calculates) a remaining memory request amount from the average memory usage amount and allocated memory usage amount of the process (step S14).

(e) Next, the memory management section 403 issues a request for physical memory to the VMM 20 (step S15). In this instance, the memory management section 403 passes (outputs) hint information for memory allocation, or more specifically, information indicative of a process generation (indicating either a long-lived process or a short-lived process) and information indicative of the predicted remaining memory request amount, to the VMM 20.

### 2. Processing Operation Performed by VMM 20

A processing operation performed by the VMM 20 will be described with reference to FIG. 2B.

(a) In accordance with the information indicative of a process generation, which was passed (input) from the OS 40, the physical memory management section 211 determines the physical memory to be allocated to the process (step S21). More specifically, if the process generation is short-lived, the physical memory management section 211 selects a physical memory for a short-lived process. If, on the other hand, the process generation is long-lived, the physical memory management section 211 selects a physical memory for a long-lived process.

(b) Next, the physical memory management section 211 determines (calculates) the total amount of available physical memory at an allocation destination and judges whether there is an allocatable area (step S22).

If the judgment result obtained in step S22 indicates that allocation is not achievable, the physical memory management section 211 judges whether an available physical memory exists (step S27).

If the judgment result obtained in step S27 indicates that an available physical memory exists, the physical memory management section 211 causes the memory power supply control section 111 to resume the power supply to the available physical memory (step S28). Upon completion of step S28, the physical memory management section 211 proceeds to step S22.

If, on the other hand, the judgment result obtained in step S27 indicates that no available physical memory exists, the physical memory management section 211 notifies the OS 40 that a page allocation process has failed (step S29). The physical memory management section 211 then terminates its processing operation.

(c) If the judgment result obtained in step S22 indicates that allocation is achievable, the physical memory management section 211 allocates a memory block of the size specified by the OS 40 (step S23). More specifically, the physical memory management section 211 updates the information contained in the memory allocation table 212 and stores the correlation between a memory area and a process assigned to the memory area in the memory allocation table 212. If the process is long-lived, the physical memory management section 211 locates a virtual memory area corresponding to a long-lived physical memory in accordance with the address conversion table 213 and assigns the long-lived process to the located virtual memory area. If, on the other hand, the process is short-lived, the physical memory management section 211 locates a virtual memory area corresponding to a short-lived physical memory in accordance with the address conversion table 213 and assigns the short-lived process to the located virtual memory area.

(d) Next, in accordance with the information indicative of the predicted remaining memory request amount, which was passed (input) from the OS 40, the physical memory management section 211 judges whether the predicted remaining memory request amount is not larger than the amount of available physical memory (step S24).

If the judgment result obtained in step S24 indicates that the predicted remaining memory request amount is not larger than the amount of available physical memory, the physical memory management section 211 judges whether an available physical memory exists (step S25). If, on the other hand, the judgment result obtained in step S24 indicates that the predicted remaining memory request amount is larger than the amount of available physical memory, the physical memory management section 211 terminates its processing operation.

If the judgment result obtained in step S25 indicates that an available physical memory exists, the physical memory management section 211 causes the memory power supply control section 111 to resume the power supply to the available physical memory in preparation for a future memory allocation request (step S26). It, on the other hand, the judgment result obtained in step S25 indicates that no available physical memory exists, the physical memory management section 211 terminates its processing operation.

When the process ends, the memory power consumption reduction system deallocates the memory allocated to the process. The processing operation performed for such memory deallocation will now be described with reference to FIGS. 3A and 3B.

### 1. Processing Operation Performed by OS 40

First of all, a processing operation performed by the OS 40 will be described with reference to FIG. 3A.

(a) When the process ends, the process management section 401 acquires the startup time and maximum memory usage amount of the process in order to deallocate the memory allocated to the process. In addition, the process management section 401 acquires (extracts) the average startup time, average memory usage amount, and startup count of the process from the process statistical information storage section 402 (step S31).

(b) Next, the process management section 401 acquires (extracts) the average startup time of all processes from the process statistical information storage section 402 (step S32).

(c) Next, the memory management section 403 compares the startup time of the process against the average startup time of all processes. If the startup time of the process is longer than the average startup time of all processes, the memory management section 403 concludes that the process is long-lived. If, on the other hand, the startup time of the process is shorter than the average startup time of all processes, the memory management section 403 concludes that the process is short-lived (step S33).

(d) Next, in accordance with the previous average startup time and average memory usage amount of the process and the current startup time and maximum memory usage amount of the process, the process management section 401 calculates average values and stores them in the process statistical information storage section 402 (step S34).

(e) Next, the process management section 401 updates the average startup time of all processes and stores it in the process statistical information storage section 402 (step S35).

(f) Next, the memory management section 403 requests the VMM 20 to deallocate a physical memory allocated to the process (step S36). In this instance, the memory management section 403 passes (outputs) hint information for memory deallocation, or more specifically, information indicative of a process generation (indicating either a long-lived process or a short-lived process), to the VMM 20.

### 2. Processing Operation Performed by VMM 20

A processing operation performed by the VMM 20 will be described with reference to FIG. 3B.

(a) When the memory management section 403 specifies the generation of the process to be handled by the VMM 20 and executes a request for memory deallocation, the physical memory management section 211 deallocates a specified memory block in accordance with the request (step S41). More specifically, the physical memory management section 211 updates the information contained in the memory allocation table 212 and erases the information indicative of a process assigned to a memory area from the memory allocation table 212.

(b) Next, in accordance with the information indicative of a process generation, which was passed (input) from the memory management section 403, the physical memory management section 211 determines the physical memory to be subjected to memory compaction (step S42).

(c) Next, the physical memory management section 211 determines (calculates) the total amount of available physical memory on an individual generation basis. The physical memory management section 211 then judges whether a threshold value is exceeded by the calculated total amount of available physical memory (step S43).

(d) If the judgment result obtained in step S43 indicates that the threshold value is exceeded, the physical memory management section 211 moves a currently used page of a physical memory to another physical memory (memory compaction) (step S44). If, on the other hand, the judgment result obtained in step S43 indicates that the threshold value is not exceeded, the physical memory management section 211 terminates its processing operation.

(e) Next, the physical memory management section 211 judges whether an available physical memory can be allocated (step S45).

(f) If the judgment result obtained in step S45 indicates that an available physical memory can be allocated, the physical memory management section 211 instructs (by transmitting a request) the memory power supply control section 111 to shut off the power supply to the available physical memory. Then, in accordance with the instruction (request) of the physical memory management section 211, the memory power supply control section 111 shuts off the power supply to the available physical memory (step S46). Subsequently, the physical memory management section 211 terminates its processing operation.

If, on the other hand, the judgment result obtained in step S45 indicates that no available physical memory can be allocated, the physical memory management section 211 terminates its processing operation.

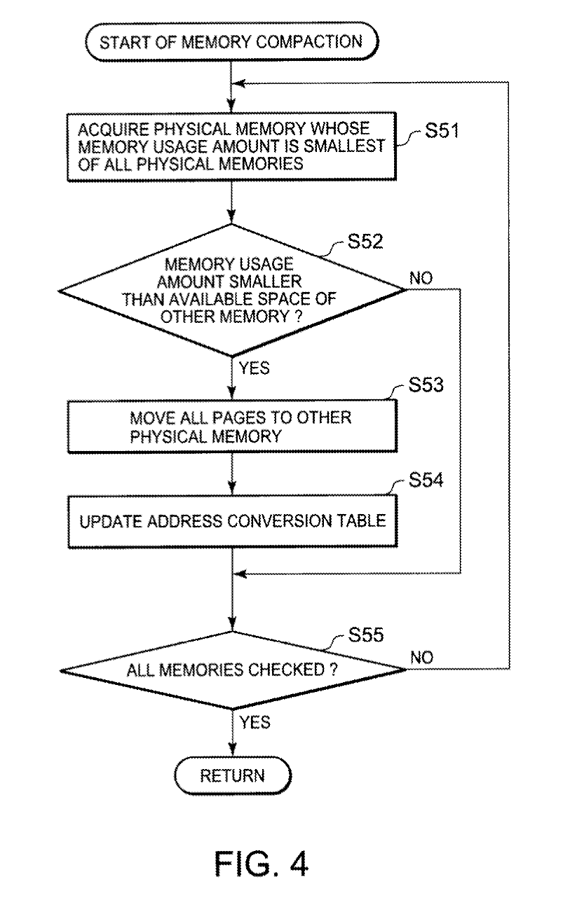

Finally, the memory compaction process performed by the physical memory management section 211 will now be described with reference to FIG. 4. FIG. 4 is a flowchart illustrating an exemplary memory compaction process performed by the physical memory management section 211.

The physical memory management section 211 acquires (locates) a physical memory whose memory usage amount is the smallest of all physical memories of a generation to be subjected to memory compaction (step S51).

Next, the physical memory management section 211 compares the memory usage amount of a physical memory from which a page is to be moved and the amount of available physical memory at a candidate destination. The physical memory management section 211 then judges whether the memory usage amount of the physical memory from which the page is to be moved is not larger than the amount of available physical memory at the candidate destination (step S52).

If the judgment result obtained in step S52 indicates that the memory usage amount of the physical memory from which the page is to be moved is not larger than the amount of available physical memory at the candidate destination, the physical memory management section 211 moves the page stored in the physical memory (step S53). In other words, the physical memory management section 211 moves information stored in the physical memory whose memory usage amount is the smallest to a physical memory at a specific move destination. In this instance, the physical memory management section 211 identifies the generation of a process and performs a processing operation only when the process is short-lived. If the process is long-lived, the physical memory management section 211 may alternatively decrease the frequency with which the processing operation is performed.

Next, the physical memory management section 211 updates the address conversion table for the moved page (step S54).

If the judgment result obtained in step S52 indicates that the memory usage amount of the physical memory from which the page is to be moved is larger than the amount of available physical memory at the candidate destination, or if step S54 is completed, the physical memory management section 211 judges whether all the memories have been checked (step S55).

If the judgment result obtained in step S55 does not indicate that all the memories have been checked, the physical memory management section 211 proceeds to step S51. If, on the other hand, the judgment result obtained in step S55 indicates that all the memories have been checked, the physical memory management section 211 terminates its processing operation.

As described above, when a process generated by the VM comes to an end in the present exemplary embodiment, the physical memory management section 211 deallocates a physical memory area assigned to the process and performs memory compaction. The physical memory management section 211 then exercises control so as to shut off the power supply to a physical memory that is unused as a result of memory compaction. Therefore, even when the VM is operating, the power consumption of memory can be reduced.

Further, the OS and VMM in the present exemplary embodiment coordinate with each other to perform memory allocation for each process generation. When performing memory compaction, the physical memory management section 211 distinguishes between a physical memory area for a short-lived process and a physical memory area for a long-lived process. This makes it possible to reduce the cost of memory compaction.

In the present exemplary embodiment, the VMM 20 and the OS 40 coordinate with each other to perform processing operations for memory allocation and power supply management. However, the VMM 20 may alternatively perform all such processing operations. For example, the VMM 20 virtualizes a plurality of physical memories for each of the VMs 30, 31, and causes the OS 40 to recognize the virtual memory 201 and the OS 41 to recognize the virtual memory 202. This ensures that the amount of virtual memory recognized by the OS 40 or OS 41 remains unchanged even when the VMM 20 shuts off the power supply to the physical memories. Consequently, the OSes transparently control the power supply to the physical memories, thereby eliminating the necessity of corrections on the OS side.

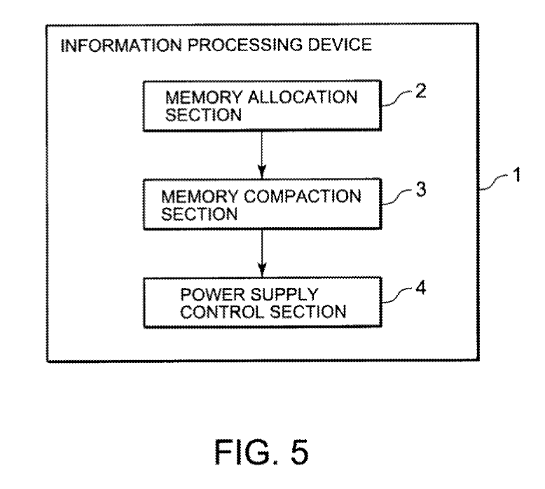

The minimum configuration of the memory power consumption reduction system according to the present invention will now be described. FIG. 5 is a block diagram illustrating an exemplary minimum configuration of the memory power consumption reduction system. As shown in FIG. 5, the memory power consumption reduction system includes an information processing device 1 as a minimum element. The information processing device 1 can generate a virtual information processing device and includes a memory allocation section 2, a memory compaction section 3, and a power supply control section 4.

In the memory power consumption reduction system having the minimum configuration shown in FIG. 5, the memory allocation section 2 allocates a physical memory area included in the information processing device to a process when it is generated in the virtual information processing device generated by the information processing device 1. When the memory allocation section 2 deallocates the physical memory area allocated to the process upon termination of the process, the memory compaction section 3 performs memory compaction. The power supply control section 4 shuts off the power supply to a physical memory that is unused as a result of memory compaction by the memory compaction section 3.

Consequently, the memory power consumption reduction system having the minimum configuration shown in FIG. 5 can reduce the power consumption of memory even when the virtual information processing device is operating.

The memory power consumption reduction system according to the present exemplary embodiment is configured to provide features (1) to (5) below.

(1) The memory power consumption reduction system includes a memory allocation section (which is implemented, for instance, by the physical memory management section 211), a memory compaction section (which is implemented, for instance, by the physical memory management section 211), and a power supply control section (which is implemented, for instance, by the physical memory management section 211 and memory power supply control section 111). The memory allocation section allocates an area of a plurality of physical memories (such as the physical memory 101) included in a physical information processing device (such as the physical server 10) to a process of a virtual machine when the virtual machine (such as the VM 30) is to be controlled with a VMM (such as the VMM 20). The memory compaction section performs memory compaction when the physical memory area allocated to the process by the memory allocation section is deallocated upon termination of the process. The power supply control section exercises control so as to shut off the power supply to a physical memory that is unused as a result of memory compaction by the memory compaction section.

(2) The memory power consumption reduction system may further include a process information storage section (which is implemented, for instance, by the process statistical information storage section 402) and a process judgment section (which is implemented, for instance, by the memory management section 403). The process information storage section stores operation history information (such as the average startup time of a process) which represents a process operation history. The process judgment section determines in accordance with the operation history information (such as the average startup time of a process and the average startup time of all processes) stored by the process information storage section whether the process is long-lived or short-lived. The memory allocation section may allocate a physical memory area with a long-lived process differentiated from a short-lived process in accordance with the judgment formed by the process judgment section. The memory compaction section may perform memory compaction for a long-lived process with one frequency and perform memory compaction for a short-lived process with another frequency.

(3) The memory power consumption reduction system may be configured so that the process judgment section compares the average startup time of a process to be generated (such as the average startup time of a process) against the average startup time of all the other processes (such as the average startup time of all processes). If the average startup time of the process to be generated is longer than the average startup time of all the other processes, the process judgment section may conclude that the process to be generated is a long-lived process. If, on the other hand, the average startup time of the process to be generated is shorter than the average startup time of all the other processes, the process judgment section may conclude that the process to be generated is a short-lived process.

(4) The memory power consumption reduction system may further include a memory request amount calculation section (which is implemented, for instance, by the memory management section 403) and an available memory amount judgment section (which is implemented, for instance, by the physical memory management section 211). The memory request amount calculation section predicts and calculates the amount of memory to be requested by a process in accordance with the operation history information (such as the average memory usage amount) stored in the process information storage section when the process is to be generated in a virtual machine. The available memory amount judgment section judges whether the memory amount calculated by the memory request amount calculation section is not larger than the available amount of physical memory operating in the information processing device. When the available memory amount judgment section judges that the memory amount calculated by the memory request amount calculation section is not larger than the available amount of physical memory operating in the information processing device and a halted physical memory exists in the information processing device, the power supply control section may exercise control so as to start the power supply to the halted physical memory.

(5) The memory power consumption reduction system may be configured so that the memory compaction section locates a physical memory whose memory usage amount is the smallest of all physical memories, and moves the whole information stored in the located physical memory to another physical memory whose available memory amount is not smaller than the memory usage amount of the located physical memory.

The present invention provides a representative effect of reducing memory power consumption even when a virtual machine is operating.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A memory power consumption reduction system comprising:
a memory allocation section which allocates an area of a plurality of physical memories included in a physical information processing device to a process of a virtual machine when the virtual machine is to be controlled with a VMM;
a memory compaction section which performs memory compaction when the physical memory area allocated to the process by the memory allocation section is deallocated upon termination of the process; and
a power supply control section which exercises control so as to shut off the power supply to a physical memory that is unused as a result of memory compaction by the memory compaction section.

2. The memory power consumption reduction system according to claim 1, further comprising:
a process information storage section which stores operation history information representing a process operation history; and
a process judgment section which determines in accordance with the operation history information stored by the process information storage section whether the process is long-lived or short-lived;
wherein the memory allocation section allocates a physical memory area with a long-lived process differentiated from a short-lived process in accordance with the judgment formed by the process judgment section; and
wherein the memory compaction section performs memory compaction for a long-lived process with one frequency and performs memory compaction for a short-lived process with another frequency.

3. The memory power consumption reduction system according to claim 2, wherein the process judgment section compares the average startup time of a process to be generated against the average startup time of all the other processes, concludes that the process to be generated is a long-lived process if the average startup time of the process to be generated is longer than the average startup time of all the other processes, and concludes that the process to be generated is a short-lived process if the average startup time of the process to be generated is shorter than the average startup time of all the other processes.

4. The memory power consumption reduction system according to claim 1, further comprising:
a memory request amount calculation section which predicts and calculates the amount of memory to be requested by a process in accordance with operation history information stored in a process information storage section when the process is to be generated in the virtual machine; and
an available memory amount judgment section which judges whether the memory amount calculated by the memory request amount calculation section is not larger than the available amount of physical memory operating in the information processing device;
wherein, when the available memory amount judgment section judges that the memory amount calculated by the memory request amount calculation section is not larger than the available amount of physical memory operating in the information processing device and a halted physical memory exists in the information processing device, the power supply control section exercises control so as to start the power supply to the halted physical memory.

5. The memory power consumption reduction system according to claim 1, wherein the memory compaction section locates a physical memory whose memory usage amount is the smallest of all physical memories, and moves the whole information stored in the located physical memory to another physical memory whose available memory amount is not smaller than the memory usage amount of the located physical memory.

6. A memory power consumption reduction system comprising:
memory allocation means which allocates an area of a plurality of physical memories included in a physical information processing device to a process of a virtual machine when the virtual machine is to be controlled with a VMM;
memory compaction means which performs memory compaction when the physical memory area allocated to the process by the memory allocation means is deallocated upon termination of the process; and
power supply control means which exercises control so as to shut off the power supply to a physical memory that is unused as a result of memory compaction by the memory compaction means.

7. A memory power consumption reduction method comprising the steps of:
allocating an area of a plurality of physical memories included in a physical information processing device to a process of a virtual machine when the virtual machine is to be controlled with a VMM;
performing memory compaction when the physical memory area allocated to the process is deallocated upon termination of the process; and
exercising control so as to shut off the power supply to a physical memory that is unused as a result of memory compaction.

8. The memory power consumption reduction method according to claim 7, further comprising the steps of:
when a process is to be generated in the virtual machine, judging in accordance with operation history information representing an operation history of the process whether the process is long-lived or short-lived;
allocating a physical memory area with a long-lived process differentiated from a short-lived process in accordance with the result of judgment; and
performing memory compaction for a long-lived process with one frequency and performing memory compaction for a short-lived process with another frequency.

9. A memory power consumption reduction program for causing a computer to execute:
a memory allocation processing operation which allocates an area of a plurality of physical memories included in a physical information processing device to a process of a virtual machine when the virtual machine is to be controlled with a VMM;
a memory compaction processing operation which performs memory compaction when the physical memory area allocated to the process is deallocated upon termination of the process; and
a power supply control processing operation which exercises control so as to shut off the power supply to a physical memory that is unused as a result of memory compaction.

10. The memory power consumption reduction program according to claim 9, the program causing a computer having a storage section for storing operation history information representing the operation history of a process to execute:
a process judgment processing operation which, when a process is to be generated in the virtual machine, judges in accordance with the operation history information whether the process is long-lived or short-lived;
a processing operation during the memory allocation processing operation to allocate a physical memory area with a long-lived process differentiated from a short-lived process in accordance with the result of judgment; and
a processing operation during the memory compaction processing operation to perform memory compaction for a long-lived process with one frequency and memory compaction for a short-lived process with another frequency.
